(19) United States
(12) Patent Application Publication
(10) Pub. No.: US 2026/0021726 A1
(43) Pub. Date: Jan. 22, 2026

(54) CHARGING SYSTEM AND CHARGING INLET

(71) Applicant: YAZAKI CORPORATION, Tokyo (JP)

(72) Inventors: Tatsuya Shiraishi, Kakegawa-shi (JP); Yasuhiro Yamaguchi, Kakegawa-shi (JP); Hideki Mizuno, Kakegawa-shi (JP); Takayuki Maruno, Kakegawa-shi (JP)

(21) Appl. No.: 19/239,922

(22) Filed: Jun. 16, 2025

(30) Foreign Application Priority Data
Jul. 22, 2024 (JP) 2024-116870

(51) Int. Cl. B60L 53/302; B60L 53/16; B60L 53/18; H01R 13/00

(52) U.S. Cl. CPC B60L 53/302; B60L 53/16; B60L 53/18; H01R 13/005; H01R 2201/26

(57) ABSTRACT

A charging system includes a charging inlet configured to charge an on-vehicle battery, a charger configured to charge the on-vehicle battery outside the vehicle, a cable drawn from the charger, a charging connector configured to be fitted to the charging inlet, a cooling device configured to cool refrigerant, and a refrigerant path configured to extend from the cooling device to the charging inlet via the charging connector and return from the charging inlet to the cooling device via the charging connector without extending to the on-vehicle battery.

### CROSS-REFERENCE TO RELATED APPLICATIONS

This application is based on and claims priority under 35 USC 119 from Japanese Patent Application No. 2024-116870 filed on Jul. 22, 2024, the contents of which are incorporated herein by reference.

### TECHNICAL FIELD

The present invention relates to a charging system and a charging inlet.

### BACKGROUND ART

In the related art, in an electric vehicle including a plug-in hybrid electric vehicle, a charging gun (charging connector) is externally connected to a charging inlet provided in a vehicle body, and an on-vehicle battery mounted on the vehicle body is charged by a charging device connected to the charging gun. In the electric vehicle, the on-vehicle battery generates heat in response to traveling by a motor, and is more appropriately cooled by a cooling mechanism provided in the vehicle body (for example, see Patent Literature 1).

### CITATION LIST

### Patent Literature

Patent Literature 1: JP2019-140740A

### SUMMARY OF INVENTION

When the on-vehicle battery of the electric vehicle is charged from the outside, there is a problem that the on-vehicle battery and the charging inlet generate heat due to Joule heat. In recent years, since it is desired to increase the capacity of the on-vehicle battery mounted on the electric vehicle and to shorten a charging time for the on-vehicle battery, this problem is remarkable.

In order to solve this problem, it is conceivable to cool the charging inlet using the cooling mechanism of the on-vehicle battery, but refrigerant that has cooled the on-vehicle battery has a certain temperature, so that there is a problem that the charging inlet cannot be effectively cooled. In order to cool the charging inlet using the cooling mechanism of the on-vehicle battery, it is necessary to install a large-capacity circulation pump, a heat exchanger, new pipe, and the like inside the electric vehicle with many restrictions to circulate the refrigerant that has cooled the on-vehicle battery inside the electric vehicle to the charging inlet, and there is a problem that the structure of the electric vehicle becomes complicated and the weight of the electric vehicle increases.

The present invention has been made in view of the above circumstances, and an object thereof is to provide a charging system and a charging inlet capable of effectively cooling the charging inlet without increasing the weight or complicating a structure of an electric vehicle.

In order to achieve the above object, a charging system according to the present invention has the following features. The charging system includes a charging inlet provided in a vehicle and configured to charge an on-vehicle battery; a charger configured to charge the on-vehicle battery outside the vehicle; a cable drawn from the charger; a charging connector provided at a distal end of the cable and configured to be fitted to the charging inlet; a cooling device provided in the charger and configured to cool refrigerant; and a refrigerant path configured to extend from the cooling device to the charging inlet via the charging connector and return from the charging inlet to the cooling device via the charging connector without extending to the on-vehicle battery.

In order to achieve the object described above, a charging inlet according to the present invention is characterized as follows. The charging inlet is provided in a vehicle and configured to charge an on-vehicle battery. The charging inlet includes an inlet-side refrigerant path through which refrigerant flowing in from a charging connector fitted to the charging inlet is returned to the charging connector without flowing toward the on-vehicle battery.

According to the charging system and the charging inlet of the present invention, it is possible to effectively cool the charging inlet without increasing the weight or complicating a structure of an electric vehicle.

The present invention has been briefly described above. Further, details of the present invention can be clarified by reading a mode (hereinafter, referred to as an “embodiment”) for carrying out the invention to be described below with reference to the accompanying drawings.

### BRIEF DESCRIPTION OF DRAWINGS

FIG. 1 is a block diagram showing a charging system and a charging inlet according to a first embodiment of the present invention;

FIG. 2 is a schematic front view showing the charging inlet;

FIG. 3 is a schematic perspective view showing the entire charging gun (charging connector);

FIG. 4 is a schematic perspective view showing a main part of the charging gun (charging connector);

FIG. 5 is a main part schematic view showing a first joint and a second joint;

FIG. 6 is a block diagram showing a charging system and a charging inlet according to a second embodiment of the present invention; and

FIG. 7 is a main part schematic view showing a switching valve of the charging system according to the second embodiment of the present invention.

### DESCRIPTION OF EMBODIMENTS

Specific embodiments of the present invention will be described below with reference to the drawings.

### First Embodiment

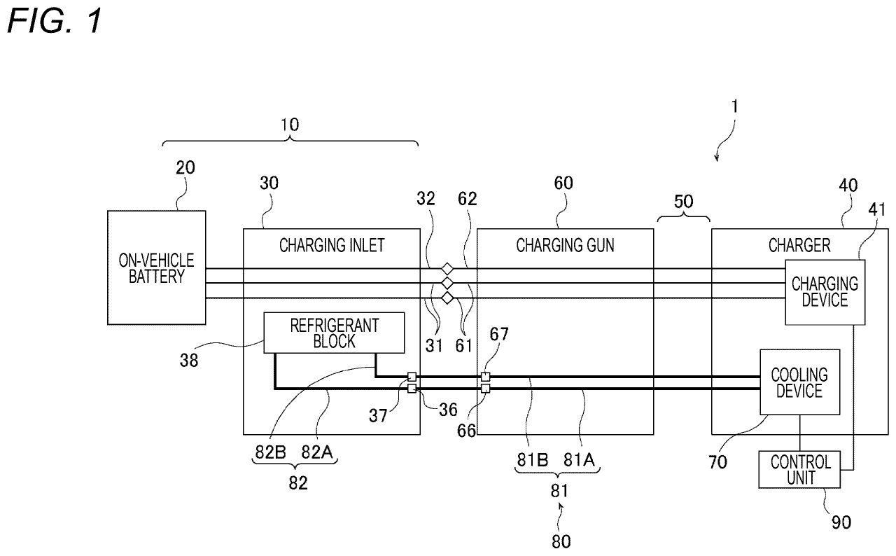

Hereinafter, a charging system and a charging inlet according to a first embodiment of the present invention will be described with reference to the drawings. As shown in FIG. 1, a charging system 1 is provided in an electric vehicle (vehicle) 10, and includes a charging inlet 30 that charges an on-vehicle battery 20, a charger 40 that charges the on-vehicle battery 20 outside the electric vehicle 10, a cable 50 that is drawn from the charger 40, and a charging gun (charging connector) 60 that is provided at a distal end of the cable 50 and is fitted to the charging inlet 30.

The charging system 1 includes a cooling device 70 that is provided in the charger 40 and cools refrigerant, and a refrigerant path 80 that extends from the cooling device 70 to the charging inlet 30 via the charging gun 60 and returns from the charging inlet 30 to the cooling device 70 via the charging gun 60 without extending to the on-vehicle battery 20. The charger 40 includes a charging device 41. Examples of the refrigerant in the refrigerant path 80 include water, coolant, and insulating oil.

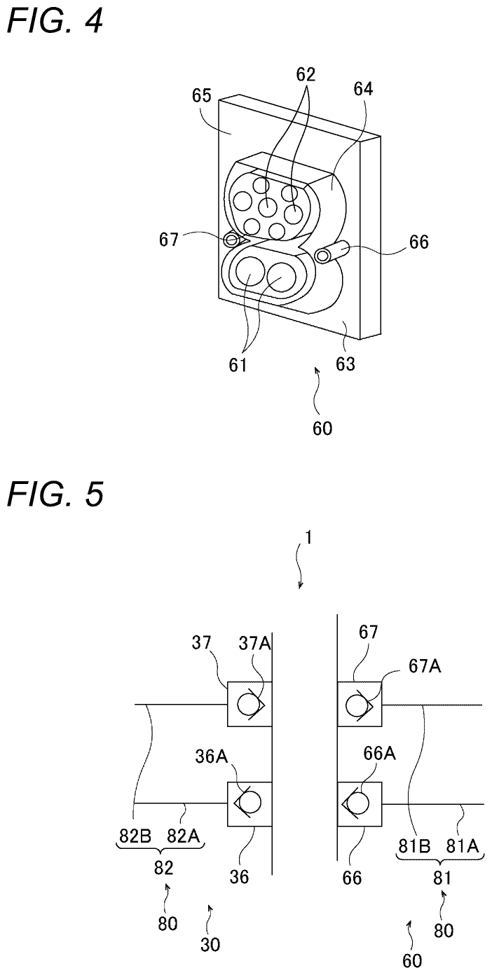

As shown in FIGS. 3 and 4, the charging gun 60 includes power supply connector terminals 61 and signal connector terminals 62 that are connected to the cable 50, and a connector housing 63 that accommodates the power supply connector terminals 61 and the signal connector terminals 62. The connector housing 63 includes a connector fitting portion 64 that accommodates the power supply connector terminals 61 and the signal connector terminals 62, and a connector base portion 65 from which the connector fitting portion 64 protrudes. The connector fitting portion 64 is formed in a wall shape surrounding the power supply connector terminals 61 and the signal connector terminals 62.

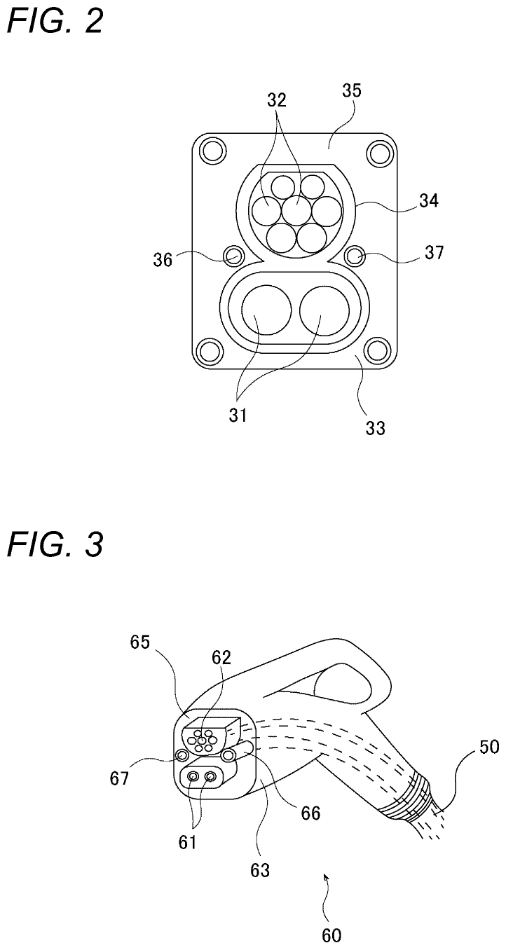

As shown in FIG. 2, the charging inlet 30 includes power supply inlet terminals 31 and signal inlet terminals 32 that are connected to the on-vehicle battery 20 (see FIG. 1), and an inlet housing 33 that accommodates the power supply inlet terminals 31 and the signal inlet terminals 32. The inlet housing 33 includes an inlet fitting portion 34 that accommodates the power supply inlet terminals 31 and the signal inlet terminals 32, and an inlet base portion 35 from which the inlet fitting portion 34 protrudes. The inlet fitting portion 34 is formed in a wall shape surrounding the power supply inlet terminals 31 and the signal inlet terminals 32.

In the charging gun 60 and the charging inlet 30, when the power supply connector terminals 61 are connected to the power supply inlet terminals 31 and the signal connector terminals 62 are connected to the signal inlet terminals 32, the connector fitting portion 64 and the inlet fitting portion 34 are fitted to each other in a nested manner to obtain airtightness, and the power supply connector terminals 61, the signal connector terminals 62, the power supply inlet terminals 31, and the signal inlet terminals 32 are blocked from outside air.

Returning to FIG. 1, the refrigerant path 80 includes a refrigerant path (gun-side refrigerant path) 81 in the charging gun 60 and a refrigerant path (inlet-side refrigerant path) 82 in the charging inlet 30. The refrigerant path 81 includes a forward path 81A and a return path 81B, and the refrigerant path 82 includes a forward path 82A and a return path 82B.

The charging gun 60 includes first joints 66, 67 on the forward path 82A and the return path 82B of the refrigerant path 82 in the charging gun 60, respectively. As shown in FIGS. 3 and 4, the first joints 66, 67 are provided outside the connector fitting portion 64 in the connector base portion 65.

Referring back to FIG. 1, the charging inlet 30 includes second joints 36, 37 on the forward path 82A and the return path 82B of the refrigerant path 82 in the charging inlet 30, respectively. As shown in FIG. 2, the second joints 36, 37 are provided outside the inlet fitting portion 34 in the inlet base portion 35. In the charging inlet 30, a refrigerant block 38 is provided at a heat generation location, and the forward path 82A and the return path 82B of the refrigerant path 82 are connected to the refrigerant block 38.

As shown in FIG. 5, the first joints 66, 67 and the second joints 36, 37 have check valves 66A, 67A, 36A, 37A, respectively. When a pump of the cooling device 70 to be described later is driven and a refrigerant pressure in the refrigerant path 80 is equal to or higher than a certain value, the check valves 66A, 67A, 36A, 37A are opened and the refrigerant circulates. When the pump stops and the refrigerant flows backward, the check valves 66A, 67A, 36A, 37A are closed to prevent the refrigerant from flowing backward and the refrigerant from flowing out from the first joints 66, 67 and the second joints 36, 37. In the charging gun 60 and the charging inlet 30, the first joint 66 and the second joint 36 are airtightly connected to each other, the first joint 67 and the second joint 37 are airtightly connected to each other, and the check valves 66A, 67A, 36A, 37A are opened to circulate the refrigerant when the pressure of the refrigerant in the refrigerant paths 81, 82 reaches a certain level or higher.

The cooling device 70 includes a radiator that cools the refrigerant, a pump that circulates the refrigerant in the refrigerant paths 81, 82, a reservoir tank that stores the refrigerant, an injection port and a discharge port that are connected to the refrigerant path 81, and other various auxiliary devices. The charging system 1 also includes a control unit 90 that controls the pump of the cooling device 70. The control unit 90 includes a computer that operates in accordance with a program, and controls the entire charging system 1. The control unit 90 appropriately adjusts a pumping speed of the refrigerant while monitoring a temperature of the on-vehicle battery 20 and the refrigerant, an increase rate of the temperature, a pressure of the refrigerant, and the like. When the temperature of the refrigerant is equal to or higher than a certain value, the control unit 90 stops charging and performs only circulation and cooling of the refrigerant.

The control unit 90 stops a pump before removing the charging gun 60 from the charging inlet 30. Examples of a condition for the control unit 90 to stop the pump include a time when the on-vehicle battery 20 is fully charged after charging is started, a time when the on-vehicle battery 20 reaches a charging capacity freely set by a user in advance, a time when a charging time freely set by the user in advance is reached, and a time when the user freely stops charging regardless of the charging capacity or the charging time. When these conditions are satisfied, the control unit 90 stops the pump, the refrigerant in the refrigerant paths 81, 82 flows backward, and the check valves 66A, 67A, 36A, 37A are closed. Accordingly, the charging gun 60 can be removed from the charging inlet 30 after the refrigerant does not leak from the first joints 66, 67 and the second joints 36, 37.

### <Operation of First Embodiment>

In the charging system 1 as described above, the user directs the charging gun 60 toward the charging inlet 30, connects the power supply inlet terminals 31 and the signal inlet 30 terminals 32 to the power supply inlet terminals 31 and the signal inlet terminal 32, respectively, connects the first joints 66, 67 to the second joints 36, 37, respectively, and fits the connector fitting portion 64 and the inlet fitting portion 34 in a nested manner. Next, in the charging system 1, when the user operates an operation panel (not shown) of the control unit 90 to select a full charging mode, a charging mode to any capacity, a charging mode to any time, or the like, the control unit 90 starts charging and drives the pump to start pumping the refrigerant. The order of an operation of the operation panel of control unit 90 by the user and an operation of connecting charging gun 60 to charging inlet 30 by the user may be reversed.

When the pump of the cooling device 70 is driven and the pressure of the refrigerant path 80 is equal to or higher than a specified value, the check valves 66A, 67A, 36A, 37A are sequentially opened, the refrigerant circulates in the refrigerant paths 81, 82, and a heat generation location of the charging inlet 30 is appropriately cooled by the refrigerant block 38. During charging, the control unit 90 appropriately adjusts a pumping speed of the refrigerant while monitoring a temperature of the on-vehicle battery 20 and the refrigerant, an increase rate of the temperature, a pressure of the refrigerant, and the like. When the charging mode selected by the user ends, the control unit 90 stops charging and stops the pump.

Next, when the pump is stopped, the refrigerant flows backward, whereby the check valves 66A, 67A, 36A, 37A are sequentially closed. An operation panel (not shown) of the control unit 90 displays that the charging gun 60 can be removed from the charging inlet 30. Even when the user removes the charging gun 60 from the charging inlet 30, the check valves 66A, 67A, 36A, 37A are closed, so that the refrigerant does not leak from the first joints 66, 67 and the second joints 36, 37.

### <Effects of First Embodiment>

As described above, the charging system 1 according to the first embodiment of the present invention includes the refrigerant path 80 that extends from the cooling device 70 to the charging inlet 30 via the charging gun 60 and returns from the charging inlet 30 to the cooling device 70 via the charging gun 60 without extending to the on-vehicle battery 20. Therefore, it is not necessary to install a large-capacity circulation pump, a heat exchanger, a new pipe, and the like inside the electric vehicle 10 with many restrictions, and the charging inlet 30 can be effectively cooled without increasing the weight or complicating the structure of the electric vehicle 10.

The charging system 1 according to the first embodiment of the present invention includes the first joints 66, 67 that connect the refrigerant path 81 in the charging gun 60 and the refrigerant path 82 in the charging inlet 30, and the second joints 36, 37 that are connected to the first joints 66, 67 and connect the refrigerant path 81 in the charging gun 60 and the refrigerant path 82 in the charging inlet 30. The first joints 66, 67 and the second joints 36, 37 have the check valves 66A, 67A, 36A, 37A, respectively. Therefore, since the control unit 90 controls the pump of the cooling device 70, even when the charging gun 60 is removed from the charging inlet 30, the refrigerant does not leak from the first joints 66, 67 and the second joints 36, 37.

Furthermore, in the charging system 1 according to the first embodiment of the present disclosure, the cooling device 70 includes a pump that circulates the refrigerant in the refrigerant path 80, and the charging system 1 includes the control unit 90 that stops the pump before the charging inlet 30 and the charging gun 60 are removed. Therefore, the charging inlet 30 can be effectively cooled by circulating the refrigerant in the refrigerant path 80, and the refrigerant can be reliably prevented from leaking from the first joints 66, 67 and the second joints 36, 37.

In the charging system 1 according to the first embodiment of the present invention, the first joints 66, 67 are provided outside the connector fitting portion 64 in the connector base portion 65, and the second joints 36, 37 are provided outside the inlet fitting portion 34 in the inlet base portion 35. Therefore, even when the refrigerant leaks from the first joints 66, 67 and the second joints 36, 37, the refrigerant does not affect the power supply connector terminals 61, the signal connector terminals 62, the power supply inlet terminals 31, and the signal inlet terminals 32 that are isolated by the connector fitting portion 64 and the inlet fitting portion 34.

The charging inlet 30 according to the first embodiment of the present disclosure includes the refrigerant path (inlet-side refrigerant path) 82 through which the refrigerant flowing from the charging gun 60 is returned to the charging gun 60 without flowing toward the on-vehicle battery 20. Therefore, it is not necessary to install a large-capacity circulation pump, a heat exchanger, a new pipe, and the like inside the electric vehicle 10 with many restrictions, and the heat generation location can be effectively cooled without increasing the weight or complicating the structure of the electric vehicle 10.

### Second Embodiment

Next, a charging system and a charging inlet according to a second embodiment of the present invention will be described. In the second embodiment to be described below, the members already described in the first embodiment are denoted by the same reference signs in the drawings, and accordingly the description thereof will be simplified or omitted.

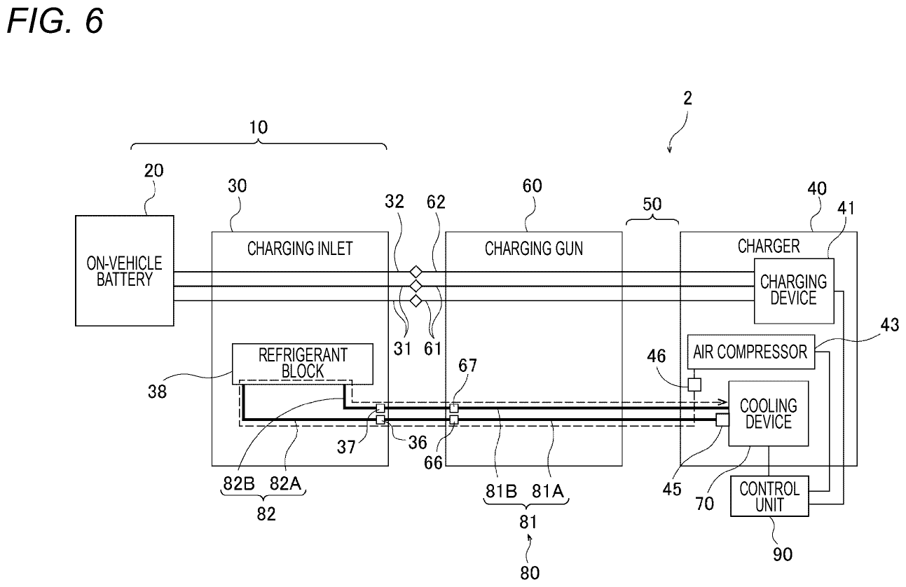

As shown in FIG. 6, a charging system 2 includes an air compressor 43 that is provided in the charger 40, injects gas into the refrigerant path 80, and returns the refrigerant to a refrigerant inlet 42 of the cooling device, and switching valves 45, 46 that switch the refrigerant path 80 between a refrigerant outlet 44 of the cooling device 70 and the air compressor 43.

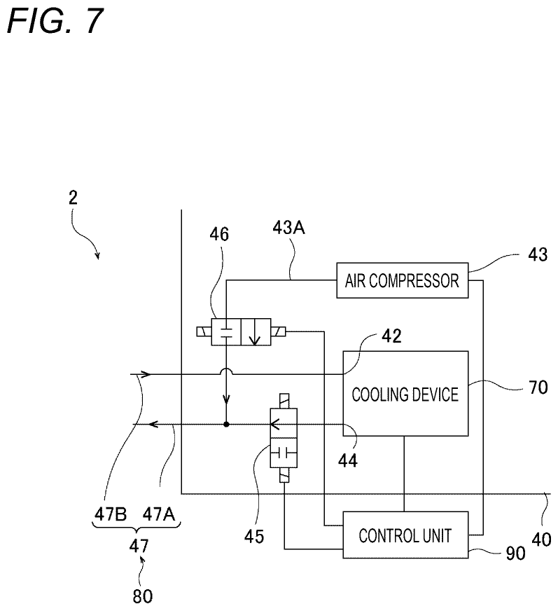

As shown in FIG. 7, the refrigerant path 80 includes a refrigerant path (cooling device-side refrigerant path) 47 in the cooling device 70, and includes a forward path 47A and a return path 47B. A discharge path 43A of the air compressor 43 is connected to the forward path 47A. The switching valve 45 is provided in the forward path 47A, and the switching valve 46 is provided in the discharge path 43A.

In the charging system 2, during charging, the switching valve 45 is opened, the refrigerant circulates through the refrigerant path 80, the switching valve 46 is closed, and the air compressor 43 is stopped. In the charging system 2, before the charging inlet 30 and the charging gun 60 are removed, the control unit 90 closes the switching valve 45 and opens the switching valve 46 to switch toward the air compressor 43, and then drives the air compressor 43. Accordingly, all the refrigerant in the refrigerant path 80 is collected in the cooling device 70.

### <Effects of Second Embodiment>

As described above, the charging system 2 according to the second embodiment of the present invention includes the refrigerant path 80 that extends from the cooling device 70 to the charging inlet 30 via the charging gun 60 and returns from the charging inlet 30 to the cooling device 70 via the charging gun 60 without extending to the on-vehicle battery 20. Therefore, similarly to the charging system 1 according to the first embodiment, the charging inlet 30 can be effectively cooled without increasing the weight or complicating the structure of the electric vehicle 10.

The charging system 2 according to the second embodiment of the present invention includes the air compressor 43 that injects gas into the refrigerant path 80 and returns the refrigerant to the refrigerant inlet 42 of the cooling device 70, and the switching valves 45, 46 that switch the refrigerant path 80 between the refrigerant outlet 44 of the cooling device 70 and the air compressor 43. Therefore, the control unit 90 switches the switching valves 45, 46 and drives the air compressor 43, so that the refrigerant in the refrigerant path 80 can be collected in the cooling device 70, and thus, even when the charging inlet 30 and the charging gun 60 are removed, the refrigerant can be reliably prevented from leaking from the first joints 66, 67 and the second joints 36, 37.

In particular, in the charging system 2 according to the second embodiment of the present invention, even when the charging inlet 30 and the charging gun 60 are removed, the refrigerant can be reliably prevented from leaking from the first joints 66, 67 and the second joints 36, 37, so that the check valves shown in the first embodiment can be omitted.

In the charging system 2 according to the second embodiment of the present invention, the control unit 90 switches the switching valve 46 toward the air compressor 43 before removing the charging inlet 30 and the charging gun 60, and then drives the air compressor 43, so that the gas can be reliably pumped into the refrigerant path 80.

Here, features of embodiments of the charging system and the charging inlet according to the present invention described above will be briefly summarized and listed in the following [1] to [7].

[1] A charging system (1, 2) including:
a charging inlet (30) provided in a vehicle (electric vehicle) (10) and configured to charge an on-vehicle battery (20);
a charger (40) configured to charge the on-vehicle battery (20) outside the vehicle (10);
a cable (50) drawn out from the charger (40);
a charging connector (charging gun) (60) provided at a distal end of the cable (50) and configured to be fitted to the charging inlet (30);
a cooling device (70) provided in the charger (40) and configured to cool refrigerant; and
a refrigerant path (80) configured to extend from the cooling device (70) to the charging inlet (30) via the charging connector (60) and return from the charging inlet (30) to the cooling device (70) via the charging connector (60) without extending to the on-vehicle battery (20).

According to the charging system (1, 2) having the configuration of the above [1], it is not necessary to install a large-capacity circulation pump, a heat exchanger, a new pipe, and the like inside the electric vehicle 10 with many restrictions, and the charging inlet 30 can be effectively cooled without increasing the weight or complicating the structure of the electric vehicle 10.

[2] The charging system (1, 2) according to [1], further including:
a first joint (66, 67) provided in the charging connector (60) and configured to connect the refrigerant path (80, 81) in the charging connector (60) and the refrigerant path (80, 82) in the charging inlet (30); and
a second joint (36, 37) provided in the charging inlet (30), connected to the first joint (66, 67), and configured to connect the refrigerant path (80, 81) in the charging connector (60) and the refrigerant path (80, 82) in the charging inlet (30), in which
the first joint (66, 67) and the second joint (36, 37) include a check valve (66A, 67A, 36A, 37A).

According to the charging system (1, 2) having the configuration of the above [2], since the check valve (66A, 67A, 36A, 37A) is provided, even when the charging connector (60) is removed from the charging inlet (30), the refrigerant does not leak from the first joint (66, 67) and the second joint (36, 37).

[3] The charging system (1, 2) according to [2], in which
the cooling device (40) includes a pump configured to circulate the refrigerant in the refrigerant path (80), and
the charging system (1) further includes a control unit (90) configured to stop the pump before the charging inlet (30) and the charging connector (60) are removed.

According to the charging system (1, 2) having the configuration of the above [3], the charging inlet (13) can be effectively cooled by circulating the refrigerant in the refrigerant path (80), and the refrigerant can be reliably prevented from leaking from the first joint (66, 67) and the second joint (36, 37).

[4] The charging system (1, 2) according to [1], further including:
a first joint (66, 67) provided in the charging connector (60) and configured to connect the refrigerant path (81) in the charging connector (60) and the refrigerant path (82) in the charging inlet (30); and
a second joint (36, 37) provided in the charging inlet (30), connected to the first joint (66, 67), and configured to connect the refrigerant path (81) in the charging connector (60) and the refrigerant path (82) in the charging inlet (30), in which
the charging connector (60) includes a connector terminal (61, 62) connected to the cable (50) and a connector housing (63) configured to accommodate the connector terminal (61, 62),
the charging inlet (30) includes an inlet terminal (31, 32) connected to the on-vehicle battery (20) and an inlet housing (33) configured to accommodate the inlet terminal (31, 32),
the connector housing (63) includes a connector fitting portion (64) configured to accommodate the connector terminal (61, 62) and a connector base portion (65) from which the connector fitting portion (64) protrudes,
the inlet housing (33) includes an inlet fitting portion (34) configured to accommodate the inlet terminal (31, 32) and be fitted to the connector fitting portion (64), and an inlet base portion (35) from which the inlet fitting portion (34) protrudes,
the first joint (66, 67) is provided outside the connector fitting portion (64) in the connector base portion (65), and
the second joint (36, 37) is provided outside the inlet fitting portion (34) in the inlet base portion (35).

According to the charging system (1, 2) having the configuration of the above [4], since the first joint (66, 67) is provided outside the connector fitting portion (64) and the second joint (36, 37) is provided outside the inlet fitting portion (34), even when the refrigerant leaks from the first joint (66, 67) and the second joint (36, 37), the refrigerant does not affect the connector terminal (61, 62) and the inlet terminal (31, 32) that are isolated by the connector fitting portion (64) and the inlet fitting portion (34).

[5] The charging system (2) according to [1], further including:
an air compressor (43) provided in the charger (40) and configured to inject gas into the refrigerant path (80) and return the refrigerant to a refrigerant inlet (42) of the cooling device (70); and
a switching valve (45, 46) configured to switch the refrigerant path (80) between a refrigerant outlet (44) of the cooling device (70) and the air compressor (43).

According to the charging system (2) having the configuration of the above [5], the refrigerant in the refrigerant path (80) can be collected by the cooling device (70), and thus, even when the charging inlet (30) and the charging connector (60) are removed, the refrigerant can be reliably prevented from leaking from the first joint (66, 67) and the second joint (36, 37), and the check valves can be omitted.

[6] The charging system (2) according to [5], further including:
a control unit (90) configured to drive the air compressor (43) after switching the switching valve (46) to the air compressor (43) side before removing the charging inlet (30) and the charging connector (60).

According to the charging system (2) having the configuration of the above [6], since the air compressor (43) is driven after the switching valve (46) is switched toward the air compressor (43), the gas can be reliably pumped into the refrigerant path 80.

[7] A charging inlet (30) provided in a vehicle (electric vehicle) (10) and configured to charge an on-vehicle battery (20), the charging inlet (30) including:
an inlet-side refrigerant path (82) through which refrigerant flowing in from a charging connector (60) fitted to the charging inlet (30) is returned to the charging connector (60) without flowing toward the on-vehicle battery (20).

According to the charging inlet (30) having the configuration of the above [7], it is not necessary to install a large-capacity circulation pump, a heat exchanger, a new pipe, and the like inside the electric vehicle (10) with many restrictions, and the heat generation location can be effectively cooled without increasing the weight or complicating the structure of the electric vehicle (10).

What is claimed is:

1. A charging system comprising:
a charging inlet provided in a vehicle and configured to charge an on-vehicle battery;
a charger configured to charge the on-vehicle battery outside the vehicle;
a cable drawn from the charger;
a charging connector provided at a distal end of the cable and configured to be fitted to the charging inlet;
a cooling device provided in the charger and configured to cool refrigerant; and
a refrigerant path configured to extend from the cooling device to the charging inlet via the charging connector and return from the charging inlet to the cooling device via the charging connector without extending to the on-vehicle battery.

2. The charging system according to claim 1, further comprising:
a first joint provided in the charging connector and configured to connect the refrigerant path in the charging connector and the refrigerant path in the charging inlet; and
a second joint provided in the charging inlet and connected to the first joint and connecting the refrigerant path in the charging connector and the refrigerant path in the charging inlet, wherein
the first joint and the second joint include a check valve.

3. The charging system according to claim 2, wherein
the cooling device includes a pump configured to circulate the refrigerant in the refrigerant path, and
the charging system further includes a control unit configured to stop the pump before the charging inlet and the charging connector are removed.

4. The charging system according to claim 1, further comprising:
a first joint provided in the charging connector and configured to connect the refrigerant path in the charging connector and the refrigerant path in the charging inlet; and
a second joint provided in the charging inlet, connected to the first joint, and configured to connect the refrigerant path in the charging connector and the refrigerant path in the charging inlet, wherein
the charging connector includes a connector terminal connected to the cable and a connector housing configured to accommodate the connector terminal,
the charging inlet includes an inlet terminal connected to the on-vehicle battery and an inlet housing configured to accommodate the inlet terminal,
the connector housing includes a connector fitting portion configured to accommodate the connector terminal and a connector base portion from which the connector fitting portion protrudes,
the inlet housing includes an inlet fitting portion configured to accommodate the inlet terminal and be fitted to the connector fitting portion, and an inlet base portion from which the inlet fitting portion protrudes,
the first joint is provided outside the connector fitting portion in the connector base portion, and
the second joint is provided outside the inlet fitting portion in the inlet base portion.

5. The charging system according to claim 1, further comprising:
an air compressor provided in the charger and configured to inject gas into the refrigerant path and return the refrigerant to a refrigerant inlet of the cooling device; and
a switching valve configured to switch the refrigerant path between a refrigerant outlet of the cooling device and the air compressor.

6. The charging system according to claim 5, further comprising:
a control unit configured to drive the air compressor after switching the switching valve to the air compressor side before removing the charging inlet and the charging connector.

7. A charging inlet provided in a vehicle and configured to charge an on-vehicle battery, the charging inlet comprising:
an inlet-side refrigerant path through which refrigerant flowing in from a charging connector fitted to the charging inlet is returned to the charging connector without flowing toward the on-vehicle battery.
